(19) United States
(12) Patent Application Publication
(10) Pub. No.: US 2026/0342904 A1
(43) Pub. Date: Oct. 29, 2026

(54) MOBILE PHONE CONTROL SYSTEM AND METHODS

(71) Applicant: Jason LUMBER, Aurora, OR (US)

(72) Inventor: Jason LUMBER, Aurora, OR (US)

(21) Appl. No.: 19/651,749

(22) Filed: Apr. 19, 2026

Related U.S. Application Data
(60) Provisional application No. 63/796,653, filed on Apr. 29, 2025.

(51) Int. Cl. H04M 1/72463; H04M 1/72484

(52) U.S. Cl. CPC H04M 1/724634; H04M 1/72484

(57) ABSTRACT

Systems and methods for controlling a mobile phone, where the mobile is configured for determining that a predetermined number of calls was made to the receiving mobile phone within a predefined time interval from an initiating mobile phone number, and that none of the predetermined number of calls was answered; automatically placing the receiving mobile phone into a locked state, and automatically transmitting an appropriate unlock code to the initiating mobile phone number. When the receiving mobile phone is in the locked state it cannot place an outgoing call to any telephone number other than a designated mobile phone number, cannot transmit an instant message to any number other than a designated mobile phone number, and cannot connect to a local network or an Internet, but remains capable of contacting emergency services.

### CROSS-REFERENCE TO RELATED APPLICATIONS

The present application claims the benefit under 35 USC 119(e) of the filing date of U.S. provisional patent application Ser. No. 63/796,653 for MOBILE PHONE CONTROL SYSTEM AND METHODS, filed Apr. 29, 2025, which is hereby incorporated by reference for all purposes.

### TECHNICAL FIELD

The present disclosure relates to providing a system and method for parental control of a mobile phone of a child. More particularly, the present disclosure relates to a system and method for ensuring that a phone call to the mobile phone of a child is answered.

### BACKGROUND

Mobile phones (i.e. cellular telephones) are ubiquitous in society, and most parents provide their children with mobile phones so that a parent or guardian can be assured of reaching their child in the event of an emergency, or simply to remain in contact during the course of the day. Unfortunately, either through carelessness or rebelliousness, some children will ignore a call from their parents, even after repeated attempts.

For example, a Common Sense Media survey (2018) reported that 75% of teens will avoid calls from their parents, while a Pew Research Center study (2016) reported that around 60% of parents expressed concern that their child might not answer when they call during an emergency.

Existing parental control tools for mobile phones typically fail to address behavior issues such as refusing to answer a parent's phone call. For example, while existing parental control tools for may provide location tracking, application use monitoring, and even screen time limits, they all rely on cooperation, and typically require a controlling mobile phone application. Unfortunately, a reasonably technically-skilled teenager may be able to disable such applications, particularly with help from online information sources, rendering them impotent. Furthermore, such parental control applications still fail to deliver on the basic functionality of mobile phones: Making and answering phone calls. Previously-known parental controls can provide no guarantee that a child will see or respond to a parent's call, especially if the child's mobile phone is set to silent, or the call is deliberately ignored.

When a child chooses not answer their phone, the parent may feel anger and frustration, as well as being made to feel powerless because they are unable to contact their child in an emergency. What is needed is a mobile phone control system that provides specificity and immediacy in enforcing communication with a child, in order to ensure the safety of the child, and to avoid the frustration of being unable to reach a child.

### SUMMARY

The present disclosure is directed to systems and methods for incentivizing a child or other dependent to answer mobile phone calls from their parent or guardian by locking the receiving mobile phone when a predetermined number of incoming calls from the same number are not answered within a predefined time interval.

In one example, the present disclosure is directed to a mobile phone control system that includes a receiving mobile phone, the mobile phone including a display, a user interface, and a processor that is configured to implement software instructions, wherein the processor of the receiving mobile phone is configured to implement software instructions for determining that a predetermined number of calls was made to the receiving mobile phone from an initiating mobile phone number, where the initiating mobile phone number is one of one or more designated mobile phone numbers, that each of the predetermined number of calls was made within a predefined time interval, and that none of the predetermined number of calls was answered; in response to determining that none of the predetermined number of calls was answered within the predefined time interval, automatically placing the receiving mobile phone into a locked state, automatically transmitting an appropriate unlock code to the initiating mobile phone number, and removing the locked state of the receiving mobile phone upon an entry of the appropriate unlock code. When the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services.

In another example, the present disclosure is directed to a method of locking a receiving mobile phone, including receiving, by the receiving mobile phone, a predetermined number of calls from an initiating mobile phone number, where the initiating mobile phone number is one of one or more designated mobile phone numbers; determining, by the receiving mobile phone, that each of the predetermined number of calls from the initiating mobile phone number was received within a predefined time interval; determining, by the receiving mobile phone, that none of the predetermined number of calls from the initiating mobile phone number was answered; in response to determining that none of the predetermined number of calls from the initiating mobile phone number was answered within the predefined time interval, automatically placing the receiving mobile phone into a locked state, where when the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services; and automatically transmitting, by the receiving mobile phone, an appropriate unlock code to the initiating mobile phone number, where the receiving mobile phone is configured to remove the locked state of the receiving mobile phone upon the appropriate unlock code being entered at the receiving mobile phone.

Additional features and advantages of the presently disclosed systems and methods will become apparent from the following drawings and description.

### BRIEF DESCRIPTION OF THE DRAWINGS

FIG. 1 is a semi-schematic illustration of an exemplary receiving mobile phone according to the present disclosure.

FIG. 2 is a semi-schematic illustration of an exemplary receiving mobile phone and an exemplary designated and or initiating mobile phone, according to the present disclosure.

FIG. 3 is a flowchart depicting an exemplary method of locking a receiving mobile phone according to the present disclosure.

FIG. 4 is a flowchart depicting an alternative and/or additional method of locking a receiving mobile phone according to the present disclosure.

FIG. 5 is a flowchart depicting an alternative and/or additional method of locking a receiving mobile phone according to the present disclosure.

### DETAILED DESCRIPTION OF PREFERRED EMBODIMENTS

The present disclosure is directed to mobile phone control systems and methods for facilitating the locking of a mobile phone in response to repeated calls made to the mobile phone going unanswered. Advantageously, the presently disclosed control system can be implemented entirely on the mobile phone itself, so that no remote access to files, apps, usage history, or real-time location is required to function. Once a lock status is triggered for the mobile phone, the only external communication required is transmission of an unlock code being sent via SMS. In this way the mobile phone user's privacy and autonomy is protected. Furthermore, the present systems are configured so that they substantially prevent misuse of the systems for surveillance or invasive control.

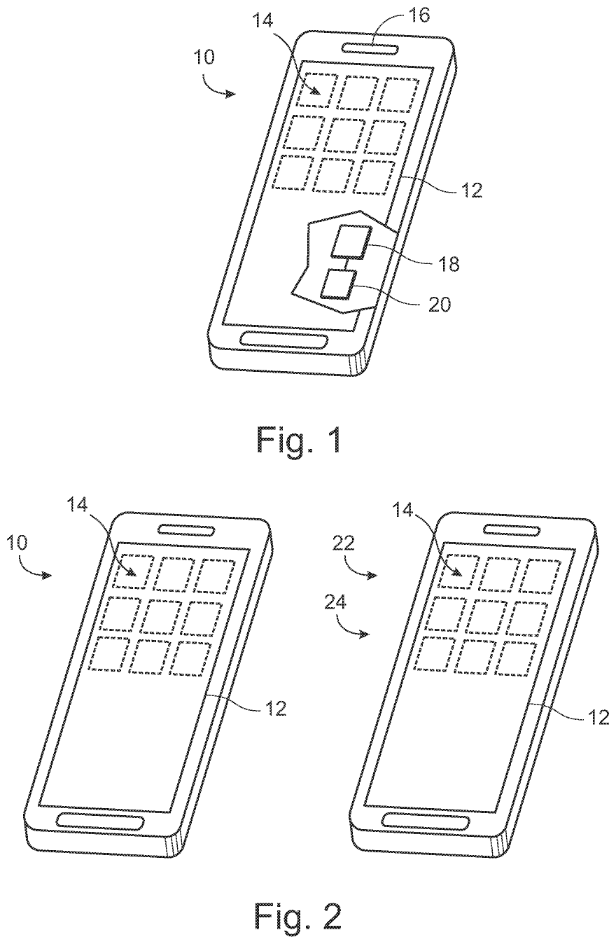

The systems and methods of the present disclosure permit control of a mobile phone. The mobile phone being controlled is referred to as a receiving mobile phone 10, and an exemplary and illustrative receiving mobile phone 10 is shown semi-Schematically in FIG. 1.

As used herein, the term mobile phone can refer to any electronic device with cellular communication capabilities. A mobile phone may be a mobile subscriber communication device, a mobile phone, a personal digital assistant (PDA), a tablet computer, an electronic book or book reader, smart glasses (e-glasses), or other electronic device without limitation.

As used herein, a mobile device typically includes a wireless transceiver apparatus to permit communicate with other systems and devices through a wireless system such as a wireless mobile telephony network, General Packet Radio Service (GPRS) network, wireless Local Area Network (WLAN), BLUETOOTH, Global System for Mobile Communications (GSM) network, Personal Communication Service (PCS) network, Advanced Mobile Phone System (AMPS) network, Infrared (IR), Near Field Communication (NFC), WIFI, IEEE 102.11 network, a Worldwide Interoperability for Microwave Access (WiMax) network, a microwave network, and/or a satellite communication network, among others. It should be appreciated that any mode of communication between a mobile device and another electronic device is an appropriate mode of communication for the purposes of the present disclosure, including a wired Internet connection, a wireless Internet connection, a cellular telephone network connection, a wireless LAN connection, a wireless WAN connection, an optical connection, a USB connection, a mobile device synchronization port connection, a power connection, and/or a security cable, among others.

The mobile phone control systems and methods for locking a mobile phone of the present disclosure may be advantageously used by a parent or guardian to incentivize a dependent child or ward to promptly answer a mobile phone call from the parent or guardian. While the present systems and methods may be particularly applicable for use by a parent in the context of a child, a parent-child relationship is not required, and any set of conditions where a guardian or person standing in loco parentis may employ the present systems and methods to ensure communication with a minor or with another individual under a guardianship or under supervision.

### Control System

As is typical for mobile phones, receiving mobile phone 10 can include a display 12 that is typically a touchscreen, where display 12 is configured to display output from receiving mobile phone 10, including stored apps, alerts and notices, and video content, among many others. Receiving mobile phone 10 additionally includes a user interface 14 that permits a user of the receiving mobile phone 10 to operate the phone. Receiving mobile phone 10 has a receiving mobile phone number, where the telephone number designates an address of receiving mobile phone 10 in a telephone network, such as the public switched telephone network (PSTN). A telephone number typically consists of, but is not limited to, a sequence of digits. Telephone numbers can facilitate the switching and routing of telephone calls using a system of destination code routing. As used herein, any calls and texts can be referred to as being sent to receiving mobile phone 10, sent to the corresponding mobile phone number for receiving mobile phone 10, or sent to the user of receiving mobile phone 10 interchangeably and without distinction.

The user interface 14 can include any number of inputs to receive commands, data, and other suitable input from a user. Typically the receiving mobile phone 10 includes one or more outputs, but typically employs display 12 or an audio speaker 16 for output to provides the user with data, notifications, and other suitable information from the receiving mobile phone 10.

In particular, while user interface 14 can include a physical keyboard or keypad, where receiving mobile phone 10 is a smartphone the user interface 14 is generally displayed and/or used in conjunction with display 12, where display 12 incorporates a touchscreen.

Receiving mobile phone 10 of FIG. 1 includes a processor 18 coupled to a memory 20 which can include volatile memory, nonvolatile memory or a combination thereof. Receiving mobile phone 10 typically further includes a communications module (not shown) that includes a wireless transceiver and a suitable power source, such as a battery (not shown).

The functionality of the receiving mobile phone 10, including the functionality and methods described herein (in whole or in part), can be implemented through processor 18 executing computer-readable instructions stored in the memory 20 of the receiving mobile phone 10.

Processor 18 can include any number and/or type of processor such as an integrated circuit microprocessor, microcontroller, and/or digital signal processor (DSP), or other suitable processing component.

Memory 20 can store any computer-readable instructions and data, including software applications, applets, and embedded operating code. Any software application used to carry out the functionality and methods described herein can also be hidden and/or locked in such a way that the software application cannot be halted or deleted by a user of the receiving mobile phone.

The memory 20 can store instructions, data, messages transmitted from (or received by) the receiving mobile phone 10, and any other suitable information. Memory 20 can include any combination of different memory storage devices, including volatile and/or nonvolatile memory, such as flash memory, ROM, PROM, EPROM, EEPROM, dynamic random-access memory (DRAM), and static random-access memory (SRAM), among others. Data can be stored in the memory 20 in any desired manner.

Systems and methods for controlling the receiving mobile phone 10 are presented in the context of at least one receiving mobile phone 10, and at least one designated mobile phone 22, as shown in FIG. 2. As will be discussed below, the present systems and methods can include a plurality of designated mobile phones 22. When the present disclosure refers to “a” designated mobile phone 22 or “the” designated mobile phone 22, this should be considered to explicitly include any or all of a plurality of such designated mobile phones 22. Each designated mobile phone 22 has a corresponding designated mobile phone number, and at least one user. As used herein, any calls and texts can be referred to as being sent to designated mobile phone 22, sent to the corresponding mobile phone number for designated mobile phone 22, or sent to the user of designated mobile phone 22 interchangeably and without distinction.

A mobile phone is a designated mobile phone 22 when the mobile phone number of that mobile phone is included in a listing of designated mobile phone numbers for receiving mobile phone 10. The listing of designated mobile phone numbers is created during setup of the present system, and corresponds to those mobile phones that are able to activate the present system. That is, the designated mobile phone numbers have been ‘designated’ to be a component of the present system. In one aspect, a user of a designated mobile phone 22 can be any person with a need or desire to maintain communication with the user of receiving mobile phone 10, such that the presently disclosed systems and methods can be used to ensure that the user of receiving mobile phone 10 will answer an incoming phone call from a designated mobile phone 22. In this example, a user of designated mobile phone 22 is typically a parent or a guardian of the user of receiving mobile phone 10, but is not limited thereto, and the user of receiving mobile phone 10 can be a child, a minor, or a ward, but is not limited thereto.

In another aspect of the present system and method, a user of a designated mobile phone 22 may be included in the listing of designated mobile phone numbers for receiving mobile phone 10 because it may be deemed important that the user of receiving mobile phone 10 maintain an ability to contact that user, even when the present system is active and receiving mobile phone 10 is otherwise in a locked state, as will be discussed below. The listing of designated mobile phone numbers may include parents, siblings, aunts, uncles, or other family members, or even trusted friends, at the discretion of the user setting up the present system on receiving mobile phone 10.

The listing of designated mobile phone numbers is therefore a pre-approved list of contacts. In one aspect, the listing of designated mobile phone numbers can be referred to as an emergency contact list, or a pre-approved emergency contact list, and each mobile phone number included in the listing of designated mobile phone numbers can be referred to as a pre-approved emergency contact number, even if they do not strictly correspond to emergency services. In theory there can be any number of contacts included in the listing of designated mobile phone numbers, but it may be more practical to limit the number of such designated mobile phone numbers. In one aspect of the present disclosure, the disclosed systems and methods may permit up to four mobile phone numbers to be included in the listing of phone number of designated mobile phones 22.

By virtue of being included in the pre-selected (pre-approved) listing of designated mobile phone numbers, incoming phone calls to receiving mobile phone 10 from designated mobile phone 22 can activate the presently disclosed system. More specifically, the processor 18 of receiving mobile phone 10 is configured to implement software instructions in order to carry out at least the following operations: Determining that a call is made to receiving mobile phone 10 from one of the designated mobile phone numbers; and determining that the call from the designated mobile phone number was not answered by the receiving mobile phone 10. The processor 18 is further configured to determine that a second and/or subsequent calls making up a predefined number of calls was made to receiving mobile phone 10 from the same designated mobile phone number within a predefined time interval; and to determine whether or not any of the predefined number of calls from the designated mobile phone number were answered. If none of the predetermined number of calls from the designated mobile phone number was answered within the predefined time interval, processor 18 is configured to automatically place receiving mobile phone 10 into a locked state. When receiving mobile phone 10 is placed into a locked state, the mobile phone from which the initiating calls were made (which is, by definition a designated mobile phone number) become an initiating mobile phone number, corresponding to an initiating mobile phone 24. The initiating mobile phone 24 can also be referred to as a triggering emergency contact.

The predetermined number of calls from a designated mobile phone 22 that may be unanswered before the mobile phone is automatically placed into a locked state is typically selectable during setup of the present system, and may be any desired number of missed calls. Typically, the predetermined number of missed calls is from 2-5. In a particular embodiment of the present disclosure, the predetermined number of missed calls is 2.

Similarly, the predefined time interval within which the predefined number of calls is received is typically selectable during setup of the present system, and may be any desired time interval. Typically, the predefined time interval is 1-10 minutes. More typically, the predefined time interval is 2-5 minutes.

The processor 18 of receiving mobile phone 10 can be further configured so that when receiving mobile phone 10 is placed in the locked state, the receiving mobile phone can display a missed call notification on display 12. Such a missed call notification can include any desired information, but may typically include a statement such as “You have one missed call,” or “Your next missed call will result in your device being locked” and/or a display of the identity of the user of the initiating mobile phone 24, and a suggestion to call the user of the initiating mobile phone. The present system may be configured so that a missed call notification is automatically removed after the expiration of the predetermined time interval from the first missed call.

The receiving mobile phone 10 is typically configured so that when receiving mobile phone 10 is placed into the locked state, receiving mobile phone 10 automatically transmits an appropriate unlock code to initiating mobile phone 24. The is, the appropriate unlock code is automatically transmitted to the designated mobile phone 22 from which the unanswered calls were made. The unlock code is not revealed to the user of receiving mobile phone 10.

An appropriate unlock code is typically randomly generated when it is needed, and can include letters, numbers, or special characters, or a common word or phrase. Typically, a generated unlock code is unique, and is appropriate for (or corresponds to) a particular lock state for a particular receiving mobile phone 10. If the appropriate unlock code is subsequently received by receiving mobile phone 10, the locked state of receiving mobile phone 10 is removed.

As the appropriate unlock code is transmitted automatically to initiating mobile phone 24, the user of receiving mobile phone 10 is unable to enter the appropriate unlock code (and unlock their phone) unless they have obtained the unlock code from the user of initiating mobile phone 24. This incentivizes the user of receiving mobile phone 10 to contact the user of initiating mobile phone 24, whose incoming calls they have not answered. As a result, it is likely that communication will be established between the user of initiating mobile phone 24 and the user of receiving mobile phone 10, which was an original intention of the unanswered triggering mobile phone calls. Such communication can be particularly important where an emergency has occurred, or where time-sensitive information must be obtained by the user of initiating mobile phone 24, Bu it is the reestablishment of communication that is the preferred goal of the presently disclosed system, rather than punishment, or to serve as remote supervision, regardless of the particular nature of the originally desired communication.

When receiving mobile phone 10 is placed into a locked state, receiving mobile phone 10 is prevented from placing an outgoing call to any telephone number other than one of the pre-approved designated mobile phone numbers, and cannot transmit an instant message to any telephone number other than one of the designated mobile phone numbers. Similarly, while the receiving mobile phone 10 can remain connected to a local communication network or an Internet, so as to remain in contact with initiating mobile phone 24, the user of receiving mobile phone 10 is prevented from accessing the local communication network or Internet for substantially any purpose other than contacting a designated mobile phone, particularly initiating mobile phone 24. As an exception, in every event and even when in the locked state, receiving mobile phone 10 remains capable of contacting emergency services if needed, such as 911.

Receiving mobile phone 10 will remain in a locked state until the appropriate unlock code is entered into the phone by the user of receiving mobile phone 10, where the appropriate unlock code is the randomly-generated code that was transmitted to the initiating mobile phone 24 when receiving mobile phone 10 was placed into a lock condition. As the presently disclosed system is configured and intended to operate, the appropriate unlock code should be obtained by the user of receiving mobile phone 10 by calling the initiating mobile phone 24 and requesting it. Typically, the appropriate unlock code is provided to the user of mobile phone 10 verbally in a voice call, providing the user of the initiating mobile phone 24 the desired contact and communication with the user of mobile phone 10. Alternatively, or in addition, the appropriate unlock code may be transmitted by SMS, or any other suitable method, if the user of the initiating mobile phone 24 agrees to do so.

Processor 18 of receiving mobile phone 10 is further configured so that after receiving mobile phone 10 is placed into the locked state, receiving mobile phone 10 can display a locked state notification. Such a locked state notification can include any desired information, such as “Your device is locked,” or “You have not answered X calls from (initiating mobile phone number),” and/or a notice that the user of the receiving mobile phone must call the initiating mobile phone number in order to get their device unlocked.

Entering the appropriate unlock code into receiving mobile phone 10 can result in receiving mobile phone 10 being returned to an unlocked state. The receiving mobile phone 10 is further configured so that if an incorrect unlock code (i.e. an inappropriate unlock code) is entered at receiving mobile phone 10, the mobile phone will not be unlocked. Optionally, mobile phone 10 is further configured so that an attempt to enter an incorrect unlock code can trigger the transmission of a newly-generated appropriate unlock code to initiating mobile phone 24. During setup, receiving mobile phone 10 may be configured so that an incorrect code must be entered a predetermined number of times before the transmission of a new appropriate unlock code. In one aspect, an incorrect unlock code must be entered from one to three times before the transmission of a new appropriate unlock code to initiating mobile phone 24. Additionally or alternatively, the attempted entry of an incorrect unlock code one or more times can result in the display by receiving mobile phone 10 that an incorrect attempt has been made.

In a further aspect of the presently disclosed system, receiving mobile phone 10 can be further configured so that when receiving mobile phone 10 is placed in a locked state, processor 18 automatically transmits a single GPS location pin to initiating mobile phone 24. The GPS location pin reflects the location of receiving mobile phone 10 (receiving mobile phone location) at the time is was placed in a lock status. The GPS location pin can be transmitted via SMS or other messaging system. Typically, receiving mobile phone 10 can be configured so that each time mobile phone 10 is placed in a locked state as a result of missing repeated calls from a designated mobile phone 22, receiving mobile phone 10 automatically transmits a corresponding GPS location pin to the appropriate initiating mobile phone 24. In this way the location of receiving mobile phone 10 (and the user of receiving mobile phone 10) can be monitored without enabling continuous location tracking or saving location data, and thereby avoiding a violation of the privacy of the user of receiving mobile phone 10.

In another aspect of the present disclosure, if receiving mobile phone 10 is taken offline, or powered off when it was, or would have been, placed into a locked state, processor 18 will capture and transmit a single GPS location pin when connectivity and/or power is restored to receiving mobile phone 10. If, while in a locked state, receiving mobile phone 10 is disconnected from wifi, cellular telephone connections, or other communication networks, all communications that would have been sent to initiating mobile phone 24 can be stored, and then delivered to initiating mobile phone 24 when receiving mobile phone 10 is reconnected to a communication network.

In another aspect of the present disclosure, the present system can provide a further incentive for the user of receiving mobile phone 10 to contact initiating mobile phone 24. Specifically, processor 18 of receiving mobile phone 10 can be further configured so that when receiving mobile phone 10 is placed into the locked state, an additional lock signal can be transmitted by receiving mobile phone 10 that is directed to one or more additional electronic devices, with the result that the one or more additional electronic devices are also placed into a locked state.

The one or more additional electronic devices can include any desired electronic device, but can typically include an electronic device that is selected because removing its availability will be a disincentive to the user of the receiving mobile phone. For example, the additional electronic devices can include one or more of an additional mobile phone, an electronic tablet, a personal computer, and a gaming console, among others. Where the additional electronic device is a smart device, such as a smart watch, tablet, or computer, being placed in lock status can result in the display of only limited information, and/or the display of limited options for a user. In some cases, an electronic device can be placed into a lock status by altering the function of a local router, disabling an Internet connection.

In addition to automatically placing receiving mobile phone 10 into a locked state if multiple incoming calls from a designated mobile phone 22 are not answered, the system of the present disclosure may be further configured so that if receiving mobile phone 10 is turned off (i.e. powered down) so that incoming calls from a designated mobile phone 22 are prevented from being technically unanswered, the user of the designated mobile phone 22 can send a message via SMS to the receiving mobile phone 10 with a simple message such as “LOCK”. When receiving mobile phone 10 is again turned on and checks for received text messages, the receipt of the “LOCK” message from a designated mobile phone 22 will immediately and automatically place receiving mobile phone 10 into a locked state that can be removed as discussed above.

It may be that a given parent or guardian has multiple children or other dependents with whom they wish to promote prompt communication. This is readily achieves using the presently disclosed system, as each child can have the presently disclosed system set up and activated on their mobile phone. The systems can operate independently of each other, and each system Ican have its own predefined time intervals and triggering number of unanswered calls, perhaps to reflect the a degree of responsibility exhibited by each user.

The control systems of the present disclosure can be installed directly, and exclusively, on receiving mobile phone 10. While a parent or guardian necessarily must install and set up the conditions for operation of the system, the presently disclosed systems do not provide remote access to the receiving mobile phone 10. Other than receiving a single GPS location pin via SMS when receiving mobile phone 10 is placed in a locked state, the parent or guardian is not able to track the receiving mobile phone location, and cannot monitor it's use. Additionally, the present control systems are typically configured so that receiving mobile phone 10 is placed in a lock status only as a result of failing to answer a predetermined number of incoming calls from a designated mobile phone 22. In this way the parent or guardian is prevented from abusing or harassing the user of receiving mobile phone 10, helping to protect the user's privacy and autonomy.

The control system of the present disclosure can be implemented on any suitable mobile phone system. The control system can be used in the iOS environment by taking advantage of, for example, Guided Access, CallKit developer toolkit and the Core Location Framework developer toolkit, among others. The control system can be used in the Android environment by taking advantage of, for example, Device Management APIs, TelephonyManager, and the Fused Location Provider API, among others. Typically such location APIs would be used to obtain a location of receiving mobile phone 10 at the time a locked state is initiated, which can then be sent to designated mobile phone 22 as a GPS location pin. Receiving mobile phone 10 need not actively track mobile phone location.

Internet access for the mobile phones can be controlled via router API integration, offering privacy and security. For example, all communications to and from the receiving mobile phone and designated mobile phone could be end-to-end encrypted, and any processing of sensitive date can be processed locally.

### Methods

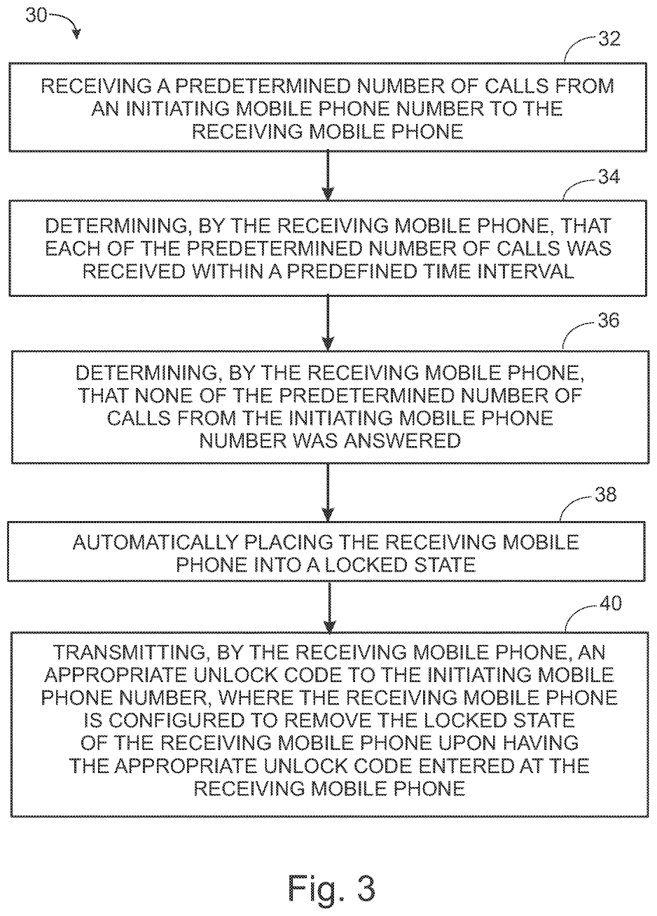

The phone control system of the present disclosure is particularly well-suited for carrying out a method of locking a receiving mobile phone, as set out in flowchart 30 of FIG. 3. As shown, the method can include receiving, by the receiving mobile phone, a predetermined number of calls from an initiating mobile phone number, at 32 of flowchart 30; determining, by the receiving mobile phone, that each of the predetermined number of calls was received within a predefined time interval, at 34 of flowchart 30; determining, by the receiving mobile phone, that none of the predetermined number of calls from the designated mobile phone number was answered, at 36 of flowchart 30; automatically placing the receiving mobile phone into a locked state, at 38 of flowchart 30; and automatically transmitting, by the receiving mobile phone, an appropriate unlock code to the designated mobile phone number, where the receiving mobile phone is configured to remove the locked state of the receiving mobile phone upon the appropriate unlock code being entered at the receiving mobile phone, at 40 of flowchart 30.

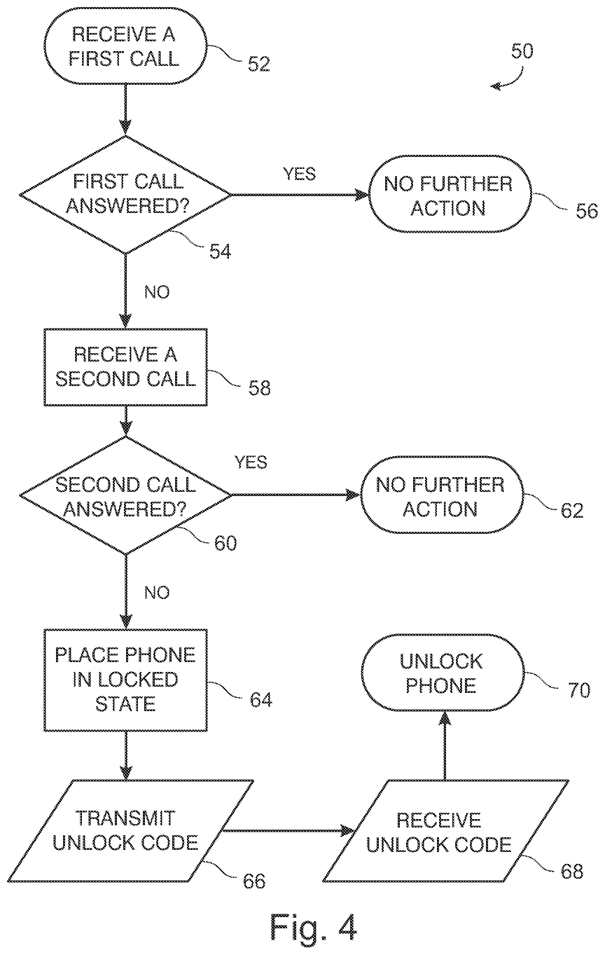

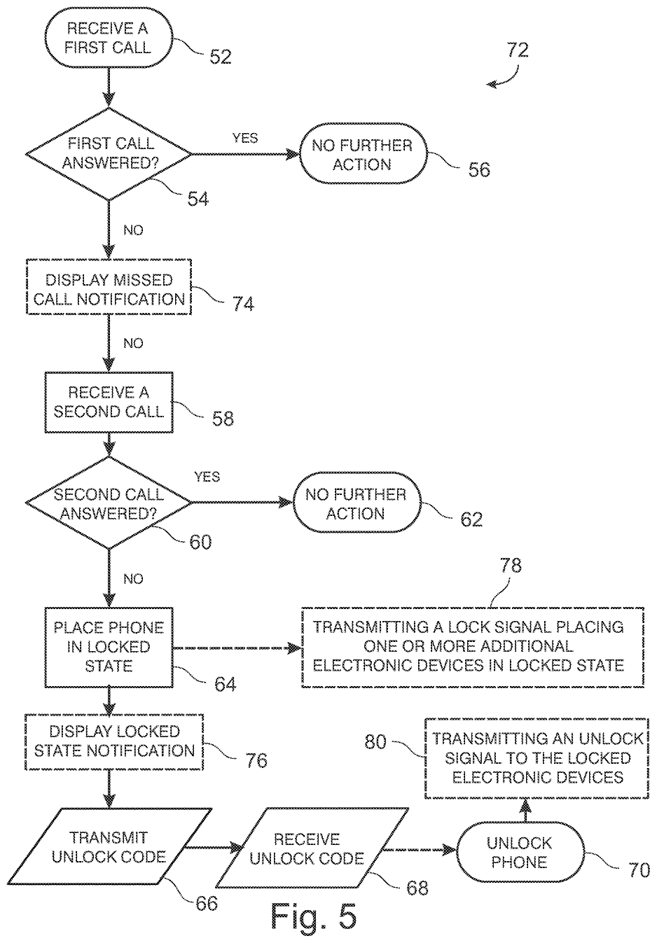

FIGS. 4 and 5 depict additional flowcharts showing alternative illustrative examples of the method of the present disclosure. For the sake of simplicity, each of flowcharts 50 and 72 of FIGS. 4 and 5, respectively, depicts an example of a method where the predetermined number of calls to be received before the receiving mobile phone is locked is 2 calls.

Similar to flowchart 30 of FIG. 3, flowchart 50 of FIG. 4 shows that if receiving mobile phone 10 receives a first call from a designated mobile phone (at 52), and the first call is answered (at 54), no further action is needed (at 56). If the first call is not answered but a second call from the designated mobile phone is received (at 58) and answered (at 60), no further action is needed (62). However, if neither the first call nor the second call are answered, the phone is placed into a locked state (at 64) and the appropriate unlock code is transmitted to the designated mobile phone (at 66). If the appropriate unlock code is provided by the user of the designated mobile phone, by phone call or text message, the unlock can then be entered into the receiving mobile phone (at 68), and the phone can be placed into an unlocked state (70).

The disclosed method can include one or more additional steps or processes, without limitation, such as is shown at 74 of flowchart 72, which includes the receiving mobile phone displaying a notification that a first incoming call from the designated mobile phone has not been answered. Alternatively, or in addition, the receiving mobile phone can display a notification that the receiving mobile phone has been placed in a locked state, at 76 of flowchart 72. Alternatively, or in addition, the disclosed method can include transmitting a lock signal that places one or more additional electronic devices into a locked state at 78 of flowchart 72. Where one or more additional electronic devices have been placed into a locked state, upon unlocking the receiving mobile phone an unlock signal can then be transmitted to the locked additional electronic devices, at 80 of flowchart 72, placing them into an unlocked state.

Although the systems and methods disclosed herein have been shown and described with reference to the foregoing operational principles and preferred embodiments, it will be apparent to those skilled in the art that various changes in form and detail can be made without departing from the spirit and scope of the invention. The present invention is intended to embrace all such alternatives, modifications and variances that fall within the scope of the appended claims.

The subject matter of the present disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties can be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. A mobile phone control system, comprising:
a receiving mobile phone including a display, a user interface, and a processor that is configured to implement software instructions, wherein the processor of the receiving mobile phone is configured to implement software instructions for:
determining that a predetermined number of calls was made to the receiving mobile phone from an initiating mobile phone number, where the initiating mobile phone number is one of one or more designated mobile phone numbers, that each of the predetermined number of calls was made within a predefined time interval, and that none of the predetermined number of calls was answered;
in response to determining that none of the predetermined number of calls was answered within the predefined time interval, automatically placing the receiving mobile phone into a locked state, and automatically transmitting an appropriate unlock code to the initiating mobile phone number;
wherein when the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services; and
removing the locked state of the receiving mobile phone upon an entry of the appropriate unlock code.

2. The mobile phone control system of claim 1, wherein the appropriate unlock code is entered by a user of the receiving mobile phone after it has been transmitted to the receiving mobile phone from the initiating mobile phone number.

3. The mobile phone control system of claim 1, wherein the predetermined number of unanswered calls is 2-5, and the predetermined time interval is 1-10 minutes.

4. The mobile phone control system of claim 1, wherein the predetermined number of unanswered calls is 2.

5. The mobile phone control system of claim 1, wherein after determining that a first call from the initiating mobile phone number is not answered, the receiving mobile phone is further configured to display a missed call notification.

6. The mobile phone control system of claim 1, wherein after placing the receiving mobile phone in the locked state, the receiving mobile phone is further configured to display a locked state notification.

7. The mobile phone control system of claim 1, wherein after placing the receiving mobile phone in the locked state, the receiving mobile phone is further configured to transmit an additional lock signal to one or more additional electronic devices thereby placing the one or more additional electronic devices into a locked state.

8. The mobile phone control system of claim 7, wherein the receiving mobile phone is further configured such that transmitting the additional lock signal includes transmitting the additional lock signal to one or more of an additional mobile phone, an electronic tablet, a personal computer, and a gaming console.

9. The mobile phone control system of claim 1, wherein upon entering the locked state the receiving mobile phone is further configured to transmit a GPS location pin for a receiving mobile phone location to the initiating mobile phone number.

10. A method of locking a receiving mobile phone, comprising:
receiving, by the receiving mobile phone, a predetermined number of calls from an initiating mobile phone number, where the initiating mobile phone number is one of one or more designated mobile phone numbers;
determining, by the receiving mobile phone, that each of the predetermined number of calls from the initiating mobile phone number was received within a predefined time interval;
determining, by the receiving mobile phone, that none of the predetermined number of calls from the initiating mobile phone number was answered;
in response to determining that none of the predetermined number of calls from the initiating mobile phone number was answered within the predefined time interval, automatically placing the receiving mobile phone into a locked state;
wherein when the receiving mobile phone is in the locked state the receiving mobile phone cannot place an outgoing call to any telephone number other than one of the designated mobile phone numbers, cannot transmit an instant message to any number other than one of the designated mobile phone numbers, and cannot connect to a local network or an Internet, but remains capable of contacting emergency services; and
automatically transmitting, by the receiving mobile phone, an appropriate unlock code to the initiating mobile phone number, wherein the receiving mobile phone is configured to remove the locked state of the receiving mobile phone upon the appropriate unlock code being entered at the receiving mobile phone.

11. The method of claim 10, wherein the predetermined number of unanswered calls is 2-5 calls, and the predetermined time interval is 1-10 minutes.

12. The method of claim 10, wherein after a first of the predetermined number of calls is received from the initiating mobile phone number is not answered, displaying by the receiving mobile phone a missed call notification.

13. The method of claim 10, wherein after the receiving mobile phone is placed into the locked state, displaying by the receiving mobile phone a locked state notification.

14. The method of claim 10, further comprising automatically transmitting, by the receiving mobile phone, an additional lock signal to one or more additional electronic devices thereby placing the one or more additional electronic devices into a locked state.

15. The method of claim 14, wherein transmitting the additional lock signal includes transmitting the additional lock signal to one or more of an additional mobile phone, an electronic tablet, a personal computer, and a gaming console.

16. The method of claim 10, further comprising entering the appropriate unlock code in the receiving mobile phone after receiving the appropriate unlock code from the initiating mobile phone number, and thereby removing the locked state of the receiving mobile phone.

17. The method of claim 10, further comprising transmitting a GPS location pin corresponding to a receiving mobile phone location to the initiating mobile phone number.
